(19) United States
(12) Patent Application Publication
(10) Pub. No.: US 2007/0294072 A1
(43) Pub. Date: Dec. 20, 2007

(54) TESTING MODEL

(76) Inventors: Ming-Shiahn Tsai, Hsinchu City (TW); Chin-Tsair Chen, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,078

(22) Filed: Jun. 16, 2006

(51) Int. Cl. G06F 17/50

(52) U.S. Cl. 703/18

(57) ABSTRACT

The invention is directed to a method for testing a chip, wherein the chip comprises a plurality of devices. The method comprises steps of screening out at least one questionable device within the chip by applying a testing model on each of the devices with a normal operating factor set and then applying the testing model on each questionable device with a plurality of operating testing factor sets so as to verify a failure cause of the chip on each questionable device.

### BACKGROUND OF THE INVENTION

1. Field of Invention

The present invention relates to a testing model. More particularly, the present invention relates to a testing model for estimate failure devices and analyzing failure causes for the failure device.

2. Description of Related Art

With the highly demanding for smaller and smaller electrical and portable equipment, the minimal feature size is decreased. However, as the minimal feature size is decreased, the current leakage seriously affects the performance of the integrated circuit than ever. For the integrated circuit design, the current leakage is an inevitable problem since the increasing of the current leakage consumes higher and higher percentage of the total power as the decreasing of the minimal feature size.

Currently, the way to diagnose the power distribution or current leakage of each power generator of the integrated circuit is to operate each power generator in a specific condition and then measure the actual internal voltage or current of each power generator. Then, by referring to the expected voltage or current value, the testing result will show whether the performance of the power generator is normal. However, the testing result only shows whether the single power generator operates normally. The testing result cannot provide any information about the defect of the integrated circuit design. That is, the testing result cannot show the actual current leakage problem causes on the integrated design or truly reflect whether the failure causes are induced by the improper process design.

### SUMMARY OF THE INVENTION

Accordingly, at least one objective of the present invention is to provide a method for estimating the operation condition of an integrated circuit. By using the method, the failure power generators are inspected and the failure causes for the power generators are analyzed.

At least another objective of the present invention is to provide a testing model for inspecting a chip. By using the testing model, the questionable devices within the chip is investigated and the testing result of the questionable device is characterized to link to the failure cause in chip design.

To achieve these and other advantages and in accordance with the purpose of the invention, as embodied and broadly described herein, the invention provides a method for estimating an operation condition of an integrated circuit, wherein the integrated circuit comprises a plurality of power generators. The method comprises steps of performing a first testing model on each of the power generators to determine a plurality of failure power generators from the power generators and then performing a second testing model on the failure power generators to obtain an failure cause of the failure power generator, wherein the second testing model has a plurality of operating testing factor sets. For each failure power generator, the second testing model comprises steps of, under each operating testing factor set, obtaining at least a first testing result, a second testing result and a third testing result by operating the power generator at a high voltage level, a low voltage level and a normal operating voltage level respectively. Then, under each operating testing factor set, characterizing the first testing result, the second testing result and the third testing result to be a failure index with respect to the operating testing factor set.

According to the one embodiment of the present invention mentioned above, the step of characterizing the first testing result, the second testing result and the third testing result comprises steps of calculating a power ratio index of the failure power generator according to the first testing result, the second testing result and the third testing result. Then, the failure index of the failure power generator under each operating testing factor set is determined according to the power ratio index of the failure power generator and a first standard power ratio index.

According to the one embodiment of the present invention mentioned above, the power ratio index is determined according to: Index P=(NR−LR)/(HR−LR), wherein Index P denotes the power ratio index, HR, LR and NR represent the first testing result, the second testing result and the third testing result.

According to the one embodiment of the present invention mentioned above, the failure index is determined according to: Index F=Index P′_{f}/Index P′_{std}, wherein Index F denotes the failure index, Index P′_{f} denotes the power ratio index of the failure power generator and Index P′_{std} represents the power ratio of the first standard power ratio index under the operating testing factor set.

According to the one embodiment of the present invention mentioned above, the first standard power ratio index is obtained by applying the second testing model on a desirable integrated circuit at an operating testing factor set under which the failure power generator operates.

According to the one embodiment of the present invention mentioned above, for each power generator of the integrated circuit, the first testing model comprises steps of, under a normal operating model, obtaining a fourth testing result, a fifth testing result and a sixth testing result by operating the power generator at the high voltage level, the low voltage level and the normal operating voltage level respectively. Then, the power ratio index of the power generator is calculated according to the fourth testing result, the fifth testing result and the sixth testing result. Moreover, a verifying index of the power generator is calculated according to the power ratio index of the power generator and a second standard power ratio index.

According to the one embodiment of the present invention mentioned above, the second standard power ratio index is obtained by applying the first testing model on a desirable integrated circuit under the normal operating model.

According to the one embodiment of the present invention mentioned above, the normal operating model is to operate the power generator with a normal operating factors including a normal operating temperature, a normal operating frequency and a normal operating pattern.

According to the one embodiment of the present invention mentioned above, the verifying index is determined according to: Index V=Index Pₚ/Index P_{std}, wherein Index V denotes the verifying index, Index Pₚ denotes the power ratio index of the power generator and Index P_{std} represents the power ratio of the second standard power ratio index.

The present invention also provides a method for testing a chip, wherein the chip comprises a plurality of devices. The method comprises steps of screening out at least one questionable device within the chip by applying a testing model on each of the devices with a normal operating factor set and then applying the testing model on each questionable device with a plurality of operating testing factor sets so as to verify a failure cause of the chip on each questionable device.

According to the one embodiment of the present invention mentioned above, in the step of screening out the questionable device, the testing model is used to generate a power ratio index of each device and a verifying index corresponding to the power ratio index of each device.

According to the one embodiment of the present invention mentioned above, the power ratio index is determined according to: Index P=(NR−LR)/(HR−LR), wherein Index P denotes the power ratio index, HR, LR and NR represent a first testing result by operating the device at a high voltage level, a second testing result by operating the device at a low voltage level and a third testing result by operating the device at a normal operating voltage level respectively.

According to the one embodiment of the present invention mentioned above, the verifying index is determined according to: Index V=Index Pₚ/Index P_{std}, wherein Index V denotes the verifying index, Index Pₚ denotes the power ratio index of the device with the normal operating factor set and Index P_{std} represents the power ratio of a first standard power ratio index of a desirable device with the normal operating factor set.

According to the one embodiment of the present invention mentioned above, in the step of applying the testing model on the questionable devices, the testing model is used to generate the power ratio index of each questionable device under each operating testing factor set and the failure index corresponding to the operating testing factor set and the power ratio index.

According to the one embodiment of the present invention mentioned above, the failure index is determined according to: Index F=Index P′_{f}/Index P′_{std}, wherein Index F denotes the failure index, Index P′_{f} denotes the power ratio index of the questionable device under the operating testing factor set and Index P′_{std} represents the power ratio of a second standard power ratio index of a desirable device under the operating testing factor set.

According to the one embodiment of the present invention mentioned above, the normal operating factor set includes a normal operating temperature, a normal operating frequency and a normal operating pattern.

In the present invention, the testing result of the devices/power generators under the normal operating factor set in high, low and normal operating voltage levels are converted into a power ratio index. By comparing the power ratio index to the standard power ratio index, the questionable device/power generator are exposed. Then, under different operating testing factor sets, the testing result of the questionable device/power generators are characterized to link to the corresponding failure causes respectively. Therefore, the problems causing the failure devices on the process design or integrated circuit design are revealed.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a flow chart schematically illustrating a method for screening out failure devices within a chip according to one embodiment of the present invention.

FIG. 1B is a flow chart schematically illustrating a method for verifying a failure cause of each failure device within a chip according to one embodiment of the present invention.

### DESCRIPTION OF THE PREFERRED EMBODIMENTS

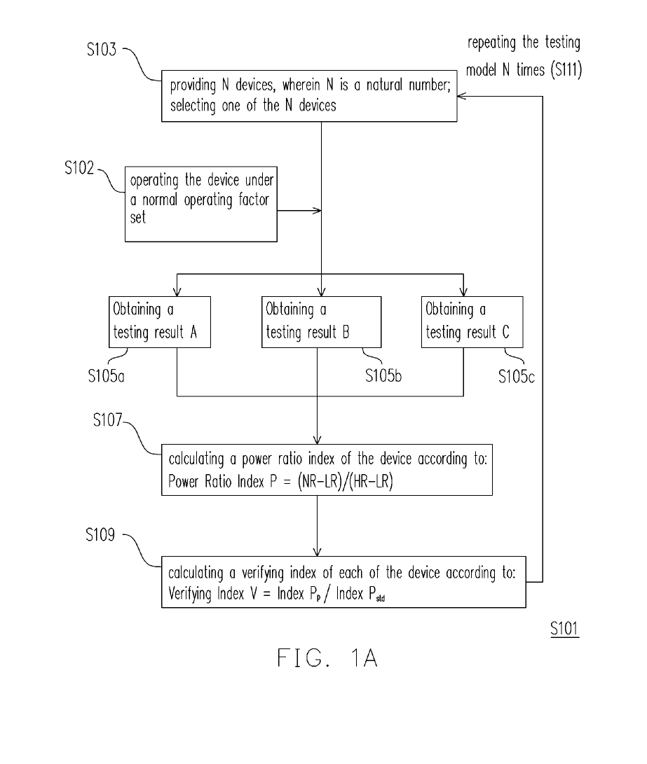

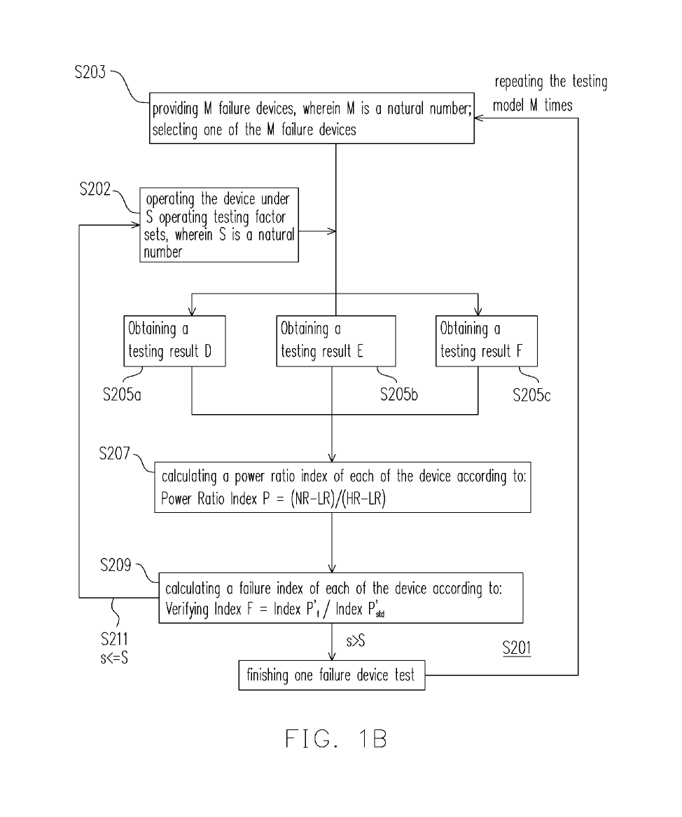

FIG. 1A is a flow chart schematically illustrating a method for screening out failure devices within a chip according to one embodiment of the present invention. FIG. 1B is a flow chart schematically illustrating a method for verifying a failure cause of each failure device within a chip according to one embodiment of the present invention. The embodiment according to the present invention illustrates a method for estimating the operation condition of a chip and finding out the possible failure cause of the failure device within the chip. However, the present invention is not limited to the problem inspection of a chip. In practice, the present invention can be further applied to diagnose the operation condition of an integrated circuit and screen out the questionable power generators so as to find out the problem of the integrated circuit design.

As shown in FIG. 1A, a testing model S101 is applied on each device, such as a power generator, of the chip. In the step S103, N devices in the chip is provided, N is a natural number. Then, under a normal operating factor set (102), each device is operated at a high voltage level, a low voltage level and a normal operating voltage level so as to obtain testing results A, B and C (steps S105a, S105b and S105c) respectively. More specifically, for each operation, one of the N devices is selected and operated at the high voltage level, the low voltage level and the normal voltage level while the other unselected devices are operated at the normal operating factor set. Noticeably, the normal operating factor set is that the chip is operated in a normal operating condition. That is, the normal operating factor set is a normal operating condition including a normal operating temperature, a normal operating frequency and a normal operating pattern. On the other words, in the step S102, each device is operated under its normal temperature, its normal operating frequency and its normal operating pattern. Furthermore, operating the device at the high voltage level means that the device is operated at its full power turned on condition. Similarly, operating the device at the low voltage level means that the device is operated at its background power condition. Also, operating the device at the normal operating voltage level means that the device is operated based on the internal voltage of the device within the chip.

The testing results A, B and C can be measured internal current values or measured internal voltage values of the device with respect to the device operating voltage level. Thereafter, a power ratio index of the device is calculated according to the testing results A, B and C of the device under the normal operating factor set (step S107). It should be noticed that the power ratio index is determined according to: Index P=(NR−LR)/(HR−LR), wherein Index P denotes the power ratio index, HR, LR and NR represent the testing result A, the testing result B and the testing result C respectively.

After step S107, a verifying index of the device is calculated according to the power ratio index of the device (step S109). Noticeably, the verifying index is determined according to: Index V=Index Pₚ/Index P_{std}, wherein Index V denotes the verifying index, Index Pₚ denotes the power ratio index of the device obtained by applying the step S107 and Index P_{std} represents a standard power ratio index of a “desirable” device operated at the normal operating factor set. That is, the ratio of the power ratio index of the device to that of the desirable device quantifies the deviation of the operation performance of the device away from the operation performance of the desirable device operated at the normal operating factor set. That is, if the verifying index is 1 or falls within a tolerable range, the device operation performance is regarded as normal. On the other hand, if the verifying index is larger or smaller than 1 or falls away from the tolerable range, the device operation performance is regarded as abnormal and the device is regarded as failure device. Then, the testing model S101 is performed N times to inspect the failure devices one by one (step S111).

As shown in FIG. 1B, for each failure device in the chip, a testing model S201 is performed to verify the failure cause of the individual failure/questionable device. In the step S203, M failure device is provided, wherein M is a natural number. Then, operating testing factor sets are provided in step S202. The operating testing factor sets are the operating conditions corresponding to diversity failure causes respectively, wherein the failure causes include leakage path between the devices, the defect of the integrated circuit design or the process design. Accordingly, each of the operating testing factor sets includes unusual operating temperature, unusual operating frequency and unusual operating pattern with respect to an individual failure cause. Similarly to the testing model S101 except under several different operating testing factor sets, each failure device is operated at the high voltage level, the low voltage level and the normal operating voltage level so as to obtain testing results D, E and F (steps S205a, S205b and S205c) respectively. Similarly to the step S107 in the testing model S101, in the step S207, a power ratio index of the failure device is calculated according to the testing results D, E and F of the failure device under one of the operating testing factor sets. It should be noticed that the power ratio index mentioned herein is also determined according to the formula: Index P=(NR−LR)/(HR−LR).

After step S207, a failure index of the failure device is calculated according to the power ratio index of the failure device (step S209). Noticeably, the failure index is determined according to: Index F=Index P′_{f}/Index P′_{std}, wherein Index F denotes the failure index, Index P′_{f} denotes the power ratio index of the questionable device operated at the predetermined operating testing factor set and Index P′_{std} represents the power ratio of a standard power ratio index of the desirable device operated at the predetermined operating testing factor set. That is, the ratio of the power ratio index of the failure device to that of the desirable device characterizes the operation performance of the failure device with the specific operating testing factor set according to the failure cause. That is, if the failure index is 1 or falls within a tolerable range, the operating testing factor set in use dose not affect the operation performance of the failure device and the failure cause relative to the operating testing factor set is not the cause for the failure device. On the other hand, if the failure index is larger or smaller than 1 or falls away from the tolerable range, the failure cause relative to the operating testing factor set in use is regarded as the cause affecting the operation performance of the failure device. Then, the testing model S201 for one failure device is performed S times to analyze the failure causes of the failure device one by one (step S211).

As mentioned, the way to determine the verifying index of the device is as same as the way to determine the failure index of the failure device except that the verifying index is obtained by operating the device with the use of the normal operating factor set and the failure index is obtained by operating the failure device with the use of several different operating testing factor sets. Therefore, the testing model S101 and the testing model S201 can be treated as one testing model which can be applied to screen out the failure elements and to find out the failure causes for the failure element. Furthermore, the present invention can be applied to estimate the operation condition of an integrated circuit as mentioned above. That is, the operation condition of the integrated circuit can be estimated by applying the testing models S101 and S201 in order on the power generators of the integrated circuit individually so as to verify the power condition of each power generator (form step S103 to step S109) and to analyze the failure cause for each failure power generator (from step S203 to step S209). Furthermore, the method according to the present invention can be applied to estimate the chip performance of each chip within one wafer so as to evaluate the process control of the processes performed to manufacturing the chips on the wafer.

Altogether, the testing result of the device/power generator is not just a measured current value or a voltage value and is characterized by applying the testing model described herein. By applying the testing model according to the present invention, the operating performances of the devices/power generators of the chip/integrated circuit under the normal operating factor set are verified. Moreover, by applying the testing model on the failure devices/power generators, the testing results of the failure devices/power generators under different operating testing factor set are characterized and link to the possible failure causes respectively. Therefore, the design of the chip/integrated circuit is modified by referring to the failure causes obtained from the testing model of the present invention.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A method for estimating an operation condition of an integrated circuit, wherein the integrated circuit comprises a plurality of power generators, the method comprising:
performing a first testing model on each of the power generators to determine a plurality of failure power generators from the power generators;
performing a second testing model on the failure power generators to obtain an failure cause of the failure power generator, wherein the second testing model has a plurality of operating testing factor sets, for each failure power generator, the second testing model comprises:
under each operating testing factor set, obtaining at least a first testing result, a second testing result and a third testing result by operating the power generator at a high voltage level, a low voltage level and a normal operating voltage level respectively; and
under each operating testing factor set, characterizing the first testing result, the second testing result and the third testing result to be a failure index with respect to the operating testing factor set.

2. The method of claim 1, wherein the step of characterizing the first testing result, the second testing result and the third testing result comprises:
calculating a power ratio index of the failure power generator according to the first testing result, the second testing result and the third testing result; and
determining the failure index of the failure power generator under each operating testing factor set according to the power ratio index of the failure power generator and a first standard power ratio index.

3. The method of claim 2, wherein the power ratio index is determined according to:
Index P=(NR−LR)/(HR−LR), wherein Index P denotes the power ratio index, HR, LR and NR represent the first testing result, the second testing result and the third testing result.

4. The method of claim 3, wherein the failure index is determined according to:
Index F=Index P′_{f}/Index P′_{std}, wherein Index F denotes the failure index, Index P′_{f} denotes the power ratio index of the failure power generator and Index P′_{std} represents the power ratio of the first standard power ratio index under the operating testing factor set.

5. The method of claim 4, wherein the first standard power ratio index is obtained by applying the second testing model on a desirable integrated circuit at an operating testing factor set under which the failure power generator operates.

6. The method of claim 2, wherein for each power generator of the integrated circuit, the first testing model comprises:
under a normal operating model, obtaining a fourth testing result, a fifth testing result and a sixth testing result by operating the power generator at the high voltage level, the low voltage level and the normal operating voltage level respectively;
calculating the power ratio index of the power generator according to the fourth testing result, the fifth testing result and the sixth testing result; and
calculating a verifying index of the power generator according to the power ratio index of the power generator and a second standard power ratio index.

7. The method of claim 6, wherein the second standard power ratio index is obtained by applying the first testing model on a desirable integrated circuit under the normal operating model.

8. The method of claim 6, wherein the normal operating model is to operate the power generator with a normal operating factors including a normal operating temperature, a normal operating frequency and a normal operating pattern.

9. The method of claim 6, wherein the verifying index is determined according to:
Index V=Index Pₚ/Index P_{std}, wherein Index V denotes the verifying index, Index Pₚ denotes the power ratio index of the power generator and Index P_{std} represents the power ratio of the second standard power ratio index.

10. A method for testing a chip, wherein the chip comprises a plurality of devices, the method comprising:
screening out at least one questionable device within the chip by applying a testing model on each of the devices with a normal operating factor set; and
applying the testing model on each questionable device with a plurality of operating testing factor sets so as to verify a failure cause of the chip on each questionable device.

11. The method of claim 10, wherein, in the step of screening out the questionable device, the testing model is used to generate a power ratio index of each device and a verifying index corresponding to the power ratio index of each device.

12. The method of claim 11, wherein the power ratio index is determined according to:
Index P=(NR−LR)/(HR−LR), wherein Index P denotes the power ratio index, HR, LR and NR represent a first testing result by operating the device at a high voltage level, a second testing result by operating the device at a low voltage level and a third testing result by operating the device at a normal operating voltage level respectively.

13. The method of claim 11, wherein the verifying index is determined according to:
Index V=Index Pₚ/Index P_{std}, wherein Index V denotes the verifying index, Index Pₚ denotes the power ratio index of the device with the normal operating factor set and Index P_{std} represents the power ratio of a first standard power ratio index of a desirable device with the normal operating factor set.

14. The method of claim 11, wherein, in the step of applying the testing model on the questionable devices, the testing model is used to generate the power ratio index of each questionable under each operating testing factor set and the failure index corresponding to the operating testing factor set and the power ratio index.

15. The method of claim 14, wherein the failure index is determined according to:
Index F=Index P′_{f}/Index P′_{std}, wherein Index F denotes the failure index, Index P′_{f} denotes the power ratio index of the questionable device under the operating testing factor set and Index P′_{std} represents the power ratio of a second standard power ratio index of a desirable device under the operating testing factor set.

16. The method of claim 10, wherein the normal operating factor set includes a normal operating temperature, a normal operating frequency and a normal operating pattern.
